(19) United States
(12) Patent Application Publication
(10) Pub. No.: US 2024/0361042 A1
(43) Pub. Date: Oct. 31, 2024

(54) MULTI-STAGE FALLING PARTICLE RECEIVER

(71) Applicant: COMMONWEALTH SCIENTIFIC AND INDUSTRIAL RESEARCH, Australian Capital Territory (AU)

(72) Inventors: Jin-Soo Kim, Australian Capital Territory (AU); Wilson Gardner, Australian Capital Territory (AU); Yen Chean Soo Too, Australian Capital Territory (AU); Daniel Potter, Australian Capital Territory (AU)

(21) Appl. No.: 18/685,338

(22) PCT Filed: Aug. 23, 2021
(86) PCT No.: PCT/AU21/50935

§ 371 Date: Feb. 21, 2024

(51) Int. Cl. F24S 20/20; F24S 70/16; F24S 80/20

(52) U.S. Cl. CPC F24S 20/20; F24S 70/16; F24S 80/20

(57) ABSTRACT

A solid particle solar receiver comprising:
a housing which includes at least one opening for receiving concentrated solar irradiance; and an inclined receiver surface about and along which particles fall downwardly from a particle inlet, the receiver surface being located in the housing in a position through which concentrated solar irradiance can incident through the at least one opening,
wherein the receiver surface comprises at least two particle falling stages, each stage separated by at least one particle retention formation configured to receive, accumulate and progressively discharging particles into a subsequent stage.
and wherein the receiver surface is configured with a frustoconical shaped curve.

### TECHNICAL FIELD

The present invention generally relates to falling particle concentrated solar receivers. The invention is particularly applicable as a particle receiver used to directly absorb concentrated solar energy in a Concentrating Solar Power/Thermal (CSP/T) system and it will be convenient to hereinafter disclose the invention in relation to that exemplary application.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

A solid particle solar receiver (SPSR) is a direct absorption central receiver that uses solid particles enclosed in a cavity to absorb concentrated solar radiation. The solid particles are heated for energy conversion, energy storage, thermochemical processes, electricity production, and process heating. Solid particle solar receivers, also known as particle receivers, typically use solid granular ceramic particles as a heat transfer medium to directly absorb concentrated solar energy directed onto those particles. The chemical and thermal stability of ceramic particles combined with the benefit of direct absorption of solar energy enables the design and operation of particle receivers to be less limited by thermal or optical constraints compared to conventional solar receivers.

One type of solid particle solar receiver uses a freely falling particle curtain directly exposed to concentrated solar energy (sunlight) through an aperture, which is open between the particles and incident concentrated solar energy, to heat the particles. However, there are some inherent drawbacks with the free-falling particles, such as the decreased volume fraction and opacity of the falling particles caused by gravitational acceleration that increases downward velocity and dispersion of the particles. The velocity of the particles in the curtain also reduces the residence time of the particles in the incident sunlight and within the receiver.

U.S. Pat. No. 10,914,493 entitled “Multi-stage falling particle receiver” (of which the current Applicant is a co-applicant) provides one solution to this issue by using a multi-stage particle falling in the particle receiver. Flow retention devices such as catch-and-release troughs were installed in vertically spaced apart locations on a flat wall along the fall path of the particles. The retention devices are designed to reduce the distance the particles fall in the receiver, reducing particle acceleration in each stage, and thus create multiple cascading stages of stable particle fall having high opacity. The use of particles that collect and flow over the trough down to the next stage also assists in protecting the trough material from direct exposure to high-flux solar irradiance which would otherwise potentially degrade the retention devices.

However, U.S. Pat. No. 10,914,493 only teaches useful laboratory-based receiver configurations. Moving to a commercially useful design requires refinement of this multi-stage falling concept in order to be practically used within a large scale Concentrating Solar Power/Thermal (CSP/T) system. In particular, the configuration of the receiver requires optimisation in order maximise the absorption of the incident solar energy into the falling particles.

It would therefore be desirable to provide a solid particle solar receiver design to resolve the aforementioned issues for implementing the multi-stage falling concept to building real falling particle receivers.

### SUMMARY OF THE INVENTION

The present invention provides a proof-of-concept multistage falling particle receivers that can be used in a concentrating solar power/thermal (CSP/T) system.

A first aspect of the present invention provides a solid particle solar receiver comprising:
a housing which includes at least one opening for receiving concentrated solar irradiance; and an inclined receiver surface about and along which particles fall downwardly from a particle inlet, the receiver surface being located in the housing in a position through which concentrated solar irradiance can incident through the at least one opening,
wherein the receiver surface comprises at least two particle falling stages, each stage separated by at least one particle retention formation configured to receive, accumulate and progressively discharging particles into a subsequent stage,
and wherein the receiver surface is configured with a frustoconical shaped curve.

The present invention therefore provides a multi-stage falling particle receiver having a falling particle receiver surface that has an advantageous conical-shaped surface geometry. In this respect, the curved receiver surface forms a subsection or portion of the outer curved surface of truncated cone (i.e. a frustoconical shape) which extends around the vertical axis of that cone. More particularly, the curved receiver surface preferably takes the shape of the hypotenuse surface of a frustoconical portion of that cone. This typically forms a vertically truncated frustoconical shaped surface geometry, which is vertically truncated in a manner that cuts a portion, for example a wedge, or other arcuate section, from the outer surface of the cone about the vertical axis of that cone. The cone geometry is frustoconical, with the top or upper portion of the receiving surface matching the larger diameter circumference of the frustoconical shape, and the bottom or lower portion of the receiving surface matching with the smaller diameter circumference of this frustoconical shape. The receiver surface therefore preferably follows an inverted frustoconical shape.

The conically shaped receiver surface advantageously provides a geometry with:
both a backwardly inclined (relative to the direction of solar incidence) and horizontally continuous surface, which is desirable for multi-stage falling particle receiver. Horizontal continuity of particle falling surface owing to the curve.
a desired curved concave configuration along the entire length of the receiver surface. The shape also moves toward maximum capture of the incident solar energy by forming a concave shape.
A converging falling path directed downwardly through the particle receiver, which can then be connected to an outlet. As particles fall down, the inverted conical shape provides narrower width with evenly thickening particle curtain, which increases solar energy absorptance.

In some embodiments, the receiver surface includes an upper section configured with a substantially cylindrically shaped curve. Like the conically shaped section, this section forms a vertically truncated cylindrical section attached to the upper end of the frustoconical receiver surface. This advantageously provides a substantially vertically orientated surface at the top of the receiver surface. The vertically orientated upper section ensures the initial particle falling from the top hopper occurs in vertical direction since the solar energy is provided to the receiver in upward direction. In these embodiments, the receiver surface therefore includes two sections—i. the vertically orientated upper section (truncated cylindrical section); and ii. the inverted truncated frustoconical shaped multi-stage particle falling section (truncated frustoconical shaped section).

The curved receiver surface can be formed from various arrangements. In some embodiments, the receiver surface can be formed from at least one curved body, for example at least one curved plate. However, for ease of construction, the receiver surface is preferably formed from two or more curved bodies such as panels or plates. In some embodiments, the receiver surface is formed from multiple curved plates or panels. In other embodiments, the receiver surface is formed a plurality of planar bodies, preferably panels, arranged to form the requisite curved surface. The planar bodies/panels are preferably tessellated to form the requisite curved surface or surfaces. In some embodiments, the receiver surface is formed from multiple flat plates or panels arranged to form a part of the requisite cylindrical or conical shape of the receiver surface.

In particular embodiments, each of the particle falling stages can be constructed as separate curved sections which are arranged, for example in a framework or other support, to provide the desired overall cone shaped curved receiver surface. This enables each particle falling section to be accurately formed with the desired shape and configuration and be individually replaced if required. In such embodiments, the receiver surface is formed from at least two curved bodies defining each particle falling stage, each curved body separated by a particle retention formation position therebetween. The at least two curved bodies can be vertically stacked along the particle falling path to form the overall frustoconical shape of the receiver surface.

Adjacent particle falling sections of the receiver surface are separated by particle retention formations. Each particle retention formation can also be formed as a separate section that can be added to the receiver surface arrangement. Again, this allows each particle retention section to be formed with the desired shape and configuration and be individually replaced if required. In embodiments, each particle retention formation comprises a removable element configured to be located between each curved body. In such embodiments, each particle retention formation can be formed as part of a sheet or plate configured to be removably located between each curved body. This configuration allows the particle retention formation to be precisely positioned between the curved bodies forming each particle falling section and where necessary allows for easy replacement and service from the back of the receiver.

The inclined surface of the truncated frustoconical shaped section of the receiver surface is important to directing the falling particles downwardly across the receiver surface and into each particle retention formation. Any suitable angle of incline can be used. In some embodiments, the receiver has a vertical axis, typically a central vertical axis, and the receiver surface is preferably inclined at an angle of 5 to 40 degrees, preferably 10 to 30 degrees from the vertical axis. In embodiments, the receiver surface is preferably inclined at an angle of 10 to 20 degrees, preferably 15 to 20 degrees from the vertical axis. In a particular example, the angle of incline is about 17.5 degrees from the vertical axis. It should be appreciated that this angle is equal to the half-apex angle of the theoretical cone from which the receiver surface has been derived. The receiver surface is typically inclined downwardly towards the direction of solar irradiance. In embodiments, the cone-shape of the receiver surface is supported by a framework to provide and maintain the required shape and configuration.

As noted above, the truncated frustoconical cone is vertically truncated in a manner that cuts a portion, for example a wedge, or other arcuate section, from the outer surface of the cone about the vertical axis of that cone. In embodiments, the receiver surface comprises a 30 to 200 degrees section of the circumferential surface of the inverted cone, preferably 50 to 180 degrees, more preferably from 60 to 180 degrees, yet more preferably 60 to 120 degrees. In some embodiments, the receiver surface comprises a 60 to 90 degree section of the circumferential surface of the inverted cone. The size of the portion or truncation angle of the frustoconical (truncated cone) surface is determined by the shape of solar field and other design factors.

The use of multiple particle falling stages help form a stable particle curtain which has a lower average particle velocity and vertical dispersion compared to a single free-falling particle curtain would experience over the total height of the receiver surface due to gravitational acceleration. Each particle falling stage is separated by at least one particle retention formation. The particle retention formation can comprise any suitable formation on or in which particles can collect such as a trough, groove, ledge, funnel, flange, elongate protrusion. Particles accumulate in the particle retention formation rather than impinge on the walls or surfaces of the particle retention formation themselves. When collected, the particles are slowed down protecting the surfaces from erosion and damage. The accumulation of particles in the trough, funnels, or ledges can be controlled actively (motorized) or passively (gravimetric counterweights, springs, variable slot apertures). In some embodiments, the particle retention formation can be used to mix the particles to enhance heat transfer and uniformity of the particle temperatures as they fall through the receiver.

In embodiments, the particle retention formation comprises at least one flange, trough, groove or ledge formed in or attached to the curved receiver surface. Each particle retention formation is preferably spaced apart from an adjacent particle retention formation along the inclined length of the receiver surface. Each particle retention formation is preferably configured to direct particle flow downward along the receiver surface and towards a base of the particle receiver.

In some embodiments, the particle retention formation comprises a series of particle collection troughs spaced apart about the length of the receiver surface for receiving and discharging particles as the particles fall through the solar receiver. The troughs collect the particles at intermittent intervals before the particles can accelerate and disperse too much.

The troughs can have any suitable configuration. In embodiments, the troughs are formed from an L-shaped ledge which extends substantially perpendicularly outwardly to the receiver surface. The L-shaped ledge cooperates with the receiver surface for form a cavity therebetween which receive, accumulate, and release the fall particles. The L-shaped ledge is preferably configured with a complementary curve with the proximate portion of the receiver surface. Any other suitable configuration possible, including C-shaped, V-shaped, U-shaped or the like.

The trough can be formed as part of the receiver surface, or alternatively separate to the receiver surface, and are affixed or otherwise positioned into place between the respective particle falling stages. As described previously, in those embodiments where each particle falling stage is formed as a distinct section, each trough shaped particle retention formation can be formed as part of a sheet or plate configured to be removably located between each curved body of the respective sections of the receiver surface.

In other embodiments, the particle retention formations may be one or more tilted or inclined ledges or surfaces that collect and release the falling particles as the particles overfill the device (creating a “waterfall” effect”). In such embodiments, the ledges may be inclined downward towards irradiance entering the solar receiver creating a cascade of falling particles. In other forms, the ledges are horizontal. In yet other forms, the ledges comprise an inclined portion and a flow barrier portion. In some embodiments, the particle retention formations comprise an L-shaped ledge. In yet other embodiments, the ledge includes grooves, trenches or other particle retaining cavities. In yet another embodiment, the flow retarding device may be any two or more of the above disclosed devices.

Where the particle retention formation comprises troughs, these troughs can be designed to accommodate variable particle mass flow rates. The objective is to decelerate the particles before they are released again. In embodiments, variable particle flow rates can be accommodated by designing the retarding troughs to allow one-side overflowing, creating a waterfall effect.

The particle retention formations are preferably positioned within the housing so that the particle retention formations are not irradiated by concentrated solar irradiance entering the receiver. In exemplary embodiments, each particle retention formation is designed to form a cascade of falling particles protect the particle retention formation from concentrated solar irradiance entering the solar receiver. The overflowing particle provide protection to the particle retention formation by shielding the material of the particle retention formation from concentrated solar irradiance entering the receiver. Here, each particle retention formation creates a cascade of falling particles. The cascade of falling particles protect the one or more flow retarding devices from concentrated solar irradiance entering the solar receiver. Each particle retention formation is therefore preferably configured to receive, accumulate and progressively discharging particles into the subsequent stage of the receiver surface, creating a cascade of falling particles away from the receiver surface as the particles fall through the receiver.

The receiver surface includes at least two particle falling stages. Any number of particle falling stages can be used. The number of stages is typically selected to achieve a desired absorptance is determined by particle size and particle curtain thickness (represented by flow rate per width of particle curtain) which is related to receiver capacity and operating condition. For large-scale receivers, high-absorptance is typically not the only reason of multi staging. Reducing falling velocity (which is related to advection heat loss) and obtaining stable curtain are desirable to be achieved. In some embodiments, the receiver surface includes at least three, preferably at least four particle falling stages. For larger receiver surfaces, the receiver surface can include 10 or more particle falling stages, in some cases 20 or more particle falling stages.

For example, in commercial particle receiver embodiments with more than 20 m falling height, the receiver surface would typically include a particle retention formation every 1 or 2 meters regardless of the absorptance. In that case, the number of stages could be tens.

The receiver surface may therefore include one or more particle retention formation depending on the number of particle falling stages required. In some embodiments, the receiver surface may include three or more particle retention formations. In yet other embodiments, the receiver surface may include between 5 to 20 particle retention formations. In yet other embodiments, the receiver surface may include between 10 and 90 particle retention formation determined by factors including, but not limited to receiver cavity size, particle flow rate and irradiance.

The receiver surface and particle retention formation therein comprise any suitable material. In embodiments, the receiver surface and particle retention formation therein comprise at least one thermally durable material, preferably tiles or casted ceramic. In other embodiments, the receiver surface and particle retention formation therein comprise a metal or metal alloy, such as stainless steel, high nickel alloys, ODS (Oxide dispersion-strengthened alloy) alloys or similar. The metal preferably has a melting point higher than 800° C.

The housing of the receiver can have any suitable configuration. In many embodiments, the housing includes a cavity in which the receiver surface is housed, the opening being formed through the housing into the cavity. This cavity is preferably thermally insulated to minimise heat loss through the housing. An insulated cavity minimises heat and particle loss and provides inlet and outlet gates of particle flow. The receiver is preferably embedded in the cavity.

The housing preferably further includes a particle feeder for feeding particles onto the receiver surface at or proximate the top of the receiver surface and a particle outlet at or proximate the bottom of the receiver surface. In embodiments, the particle outlet is located at or proximate a base of the housing. More particularly, the particle feeder is preferably located at the larger diameter of the inverted cone shape of the receiver surface and the particle outlet is preferably located at a base of the receiver surface corresponding to the smaller diameter of the inverted cone.

The particle feeder can have any suitable configuration. In embodiments, the particle feeder comprises a slot type feeder, having a curved opening slot having a matching curve to the to make the top portion of the receiver surface proximate the particle inlet. In other embodiments, the particle feeder comprises a slot type feeder having a multiple straight/planar opening slots arranged in series to have a substantially matching curve to the to make the top portion of the receiver surface proximate the particle inlet. This curved shape ensures that the initially introduced particles from the feeder form a shape matching the curved shape of receiver surface. In this configuration, the particle feeder preferably also has a slide gate for controlling the flow of the particles being fed through the feeder. The slide gate preferably comprises a curved slide gate having a complementary curved shape to the curved opening slot. That slide gate may be formed from a curved sheet of material, or where appropriate multiple planar sheets arranged in series to form the complementary curved shape to the curved opening slot.

The slide gate can be equipped with at least one actuator to control to the particle flow fed onto the receiver surface. The particle flow is preferably controlled to meet the required horizontal flow distribution. As discussed above, the particle retention formations can in some embodiments be actively or passively controlled to adjust particle flow through design and manipulation of the particle retention formations.

The receiver can include at least one flow deflector located proximate the bottom of the receiver surface. The flow deflector is configured to deflect particle motion from particles falling the final particle falling stage prior to exiting through the particle outlet. The flow deflector is preferably configured to decelerate particle velocity and separate entrained air from the particles. In this sense, the flow deflector is configured to separate entrained air from the particle flow before leaving the receiver so that the entrained hot air is recirculated and used as the entrained air required for accelerated falling. This assists in reduces advective heat loss from the receiver. The flow deflector can have any suitable configuration. In embodiments, the flow deflector comprises a curved surface (laterally/horizontally curved relative to the vertical axis of the receiver) opposing the receiver surface about the particle outlet of the receiver. The curved surface is preferably inclined, in an opposing incline to the receiver surface. In some embodiments, the flow deflector has an opposing but complementary curve to the base section of the receiver surface, forming a V-shaped trough or funnel with the base section of the receiver surface directed towards the particle outlet. In some embodiments, the flow deflector has a frustoconical shaped configuration which is preferably complementary to the frustoconical shaped configuration of the base section of the receiver surface.

The housing of the receiver can include a single aperture or multiple apertures to accommodate various sections of the particle flow as defined by the particle retention formations. Where multiple apertures, concentrated solar energy (for example in the form of heliostat beams) could be aimed through multiple apertures, with direct irradiance on the particle retention formations (which can be placed in between the apertures) being minimized to prevent overheating of the troughs. Some amount of incident light on the particle retention formations may actually be good to heat the particles, and the particle retention formations can be transparent or porous to allow light to heat the particles directly. As noted previously, the particle retention formations can be protected from direct irradiance by overflowing particles that flow over the edge facing incident concentrated solar energy, in other words, the waterfall of particles over the edge block/absorb the sunlight from the particle retention formations.

Any suitable solid particles can be used in the solar receiver of the present invention. The particles function as a heat transfer medium and typically comprise a material having high thermal capacitance as well as good thermal conductivity to enable efficient thermal absorbance and transfer. The solid particles preferably have a solar absorptance is close to or preferably higher than 90%, a heat capacity close to or preferably higher than 1.2 KJ/kg-K, and a material density is close to or preferably higher than 3500 kg/m³. In embodiments, the particles comprise ceramic particles, preferably solid granular ceramic particles, more preferably 40/70 mesh commercial ceramic proppant such as Wanli HSP 40/70 mesh (from Xinmi Wanli Industry Development Co. Ltd, Henan, China) and Carbobead HSP 40/70 mesh (from Carbo Ceramics Inc, Houston, Texas, USA).

The invention can be applied for any solar energy utilisation process especially at elevated temperatures above 700° C. involving the use of fine-grained particles as the heat transfer and thermal energy storage medium, such as the next generation CSP systems with supercritical power generation cycle.

The invention can be applied to a variety of applications which require particles as a heat transfer and thermal storage medium. Owing to the chemical and thermal stability of particles, the invention can be utilised from low temperature processes (such as steam generation system) to very high temperature processes (such as chemical reaction systems).

### BRIEF DESCRIPTION OF THE DRAWINGS

The present invention will now be described with reference to the figures of the accompanying drawings, which illustrate particular preferred embodiments of the present invention, wherein:

FIG. 1 provides schematic view of the design of one embodiment of the present invention showing a frustoconical shaped particle receiver: (a) a cut-away side view; (b) perspective view of the cone-shape receiver surface; and (c) schematic representation of the angles and dimensions of a cone on which the receiver surface is based.

FIGS. 2A to 2C provide perspective views of the particle receiver illustrated in FIG. 1 showing the particle receiver from a (2A) side view; (2B) front view; and (2C) rear view.

FIGS. 2D and 2E provide (A) a perspective view; and (B) exploded perspective view of the final construction design of the frustoconical-shaped particle receiver shown in FIG. 1.

FIG. 3 provides a visual comparison of the evolution of multi-stage falling concept with snapshots from experimental validations.

FIG. 4 provides a plot showing the solar energy absorptance of falling particles of 40/70 mesh Wanli HSP obtained by correlation equation [1] (see examples).

FIG. 5 provides a plot of the solar energy absorptance of particle curtain of the designed multi-stage truncated-cone particle receiver: It is to be noted that the plotted absorptance is for the particle curtain only not considering the presence of a cavity. Depending on the view factor to the cavity aperture, a real reflection loss caused by low absorptance will change.

FIG. 6 provides a solar energy flux map obtained by HelioSIM ray tracing as set out in D. F. Potter, J.-S. Kim, A. Khassapov, R. Pascual, L. Hetherton and Z. Zhang, Heliosim, An integrated model for the optimisation and simulation of central receiver CSP facilities, AIP Conference Proceedings 2033, 210011 (2018).

FIG. 7 provides solar flux contour plots on the receiver surfaces with a flat-tilted and a cone-shaped receiver wall.

FIG. 8 provides the results of a multi-stage particle falling simulation, showing: (a) shown with vertical velocity contour (simulation result); (b) and (c) experimental/test results showing different flow rates for truncated-cone shape design.

FIG. 9 illustrates a configuration of on-sun receiver test system: (a) 3-dimensional drawing of integrated components; and (b) simplified schematic diagram.

FIG. 10 provides size distribution of heat transfer ceramic particles used in the receiver showing (a) Carbo HSP 40/70 mesh particles; and (b) fines included in the particle product.

### DETAILED DESCRIPTION

It should be understood that various directions such as “upper”, “lower”, “bottom”, “top”, “left”, “right”, “upwardly” and “downwardly” and the like are made only with respect to explanation in conjunction with the drawings, and that the components may be oriented differently, for instance, during transportation and manufacturing as well as operation. Because many varying and different embodiments may be made within the scope of the inventive concept(s) herein taught, and because many modifications may be made in the embodiments described herein, it is to be understood that the details herein are to be interpreted as illustrative and non-limiting.

The present invention provides a proof-of-concept multistage falling particle receivers that can be used in a concentrating solar power/thermal (CSP/T) system. The solid particle solar receiver of the present invention is generally designed to optimise the configuration of an inclined wall multistage falling particle receivers.

Whilst not wishing to be limited to anyone theory, the Inventors have found that an inclined wall with particle retention formations (such as a catch-and-release troughs) is hard to practically implement within the design of real solar receivers. The inventors have found that a single tilted wall will expose huge side area which is not receiving solar energy. The particle receiver surface is therefore ideally configured with a concave shape to optimise the capture incident solar energy delivered from wide range of angular directions. However, it is difficult to build a concave shape with a tilted wall.

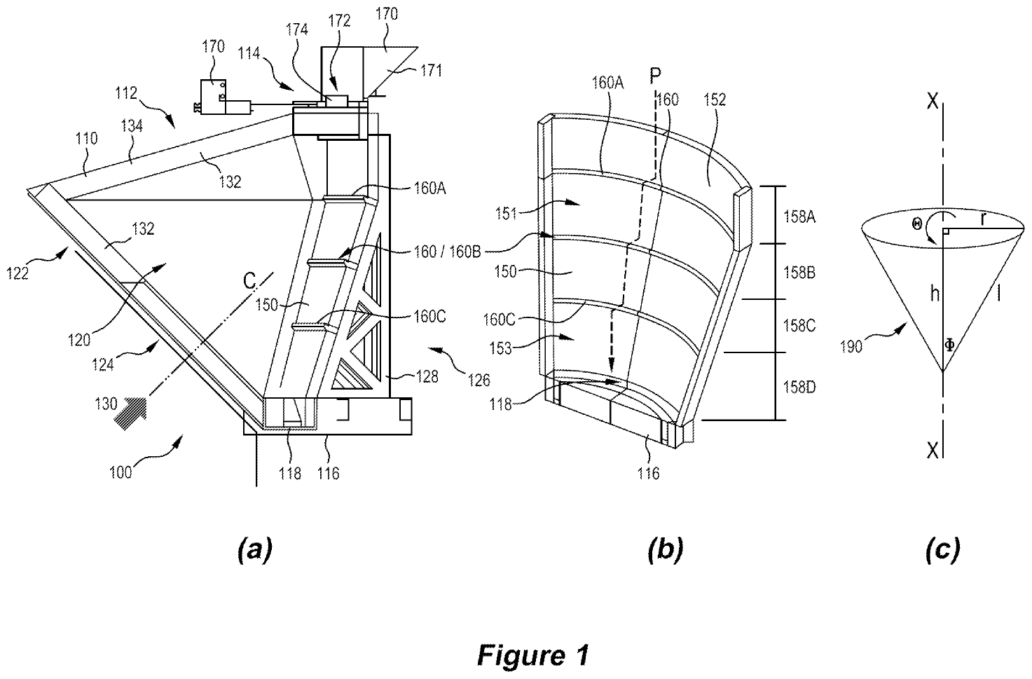

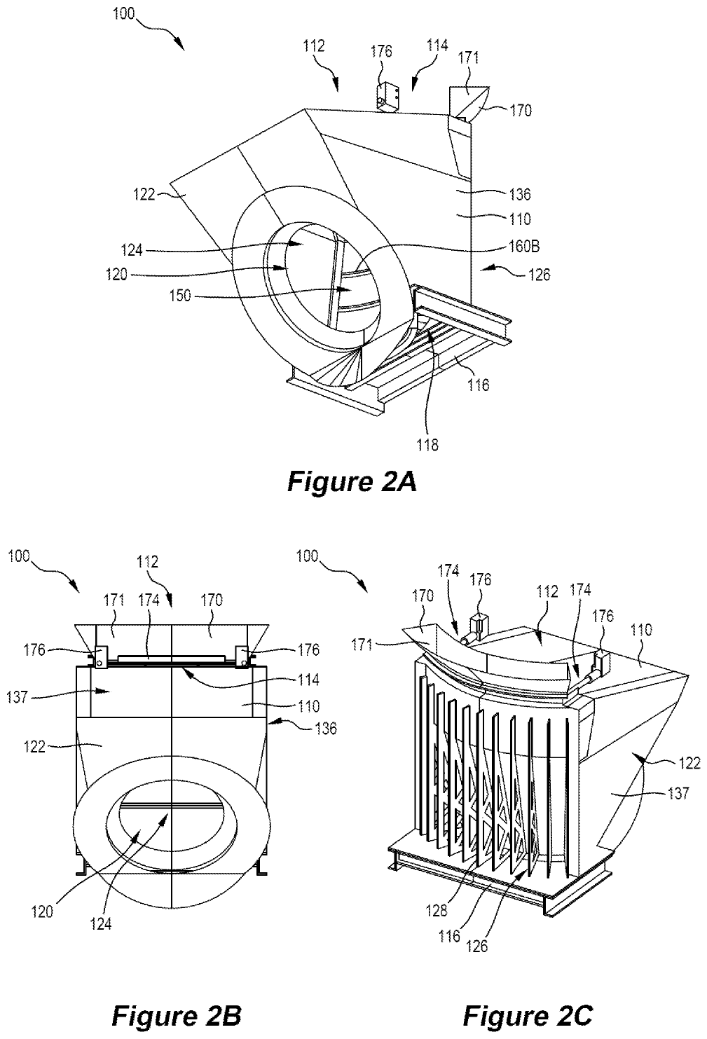

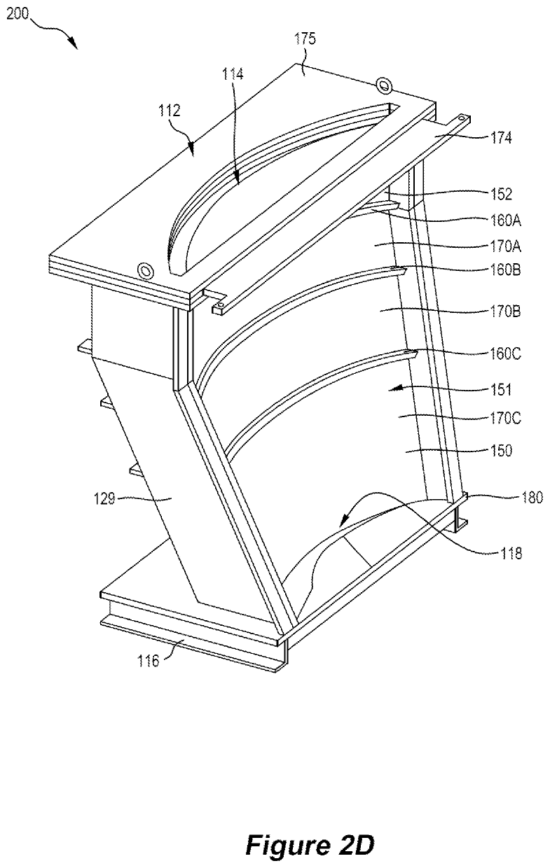

The present invention therefore provides a multi-stage falling particle receiver 100 which includes a falling particle receiver surface 150 (FIGS. 1 and 2) that adopts an advantageous conical-shaped surface geometry. The inverted cone-shape receiver surface design provides a backwardly inclined geometry coupled together with a substantially horizontally continuous surface across its curved configuration. This geometry moves the receiver configuration towards optimal capture of solar energy by forming a concave shape without the disadvantages of using multiple flat receiver panels. This geometry also allows for the receiver surface 150 to have a desired curved concave configuration along the entire width and length of that surface. The geometry also assists in providing an even horizontal particle distribution across the receiver surface.

This concave shape receiver surface can be formed from a continuously curved received surface, or multiple curved surfaces fitted together to form the required conical curve. In some embodiments, the curve can be formed using a tessellated structure of multiple flat/substantially planar panels. With an inclined receiver surfaces, the shape of individual flat falling panels ideally have a trapezoidal configuration, which are then laid together to form a concave multi-paneled surface.

Referring to FIGS. 1 and 2A, 2B and 2C, the particle receiver 100 design of the present invention comprises three main innovative parts which have been developed to practically implement this particle receiver design:
1) a housing 110 with a cavity 120;
2) a receiver surface panel 150 for receiving and guiding the falling particles (not illustrated) within the receiver 100 contained within that cavity 120; and
3) a particle feeder 170 positioned over the top edge 152 of the receiver surface 150 which includes a curved particle inlet slot 172 controlled by slide gate 174 through which the solid energy absorbing particles are fed onto the receiver surface. As described below, that curved inlet slot 172 and slide gate 174 may be formed from one or multiple openings and slide gate(s) to provide particles along the arc of the top of the receiver surface panel 150.

FIGS. 1A, 1B, 2A, 2B and 2C show different views of a multi-stage falling particle solar receiver (receiver) 100 according to one embodiment of the present invention. As can be seen in FIGS. 1, 2A to 2C the particle receiver 100 includes a housing 110 which includes the cavity 120 which contains the receiver surface panel 150 which includes curved receiver surface 151. The housing 110 further includes a housing top structure 112 which include an inlet 114 disposed within a housing top structure 112 and a base structure 116 with an outlet 118 in fluid communication to an internal chamber or cavity 120.

The housing 110 also includes a front panel 122 which includes a central opening/aperture 124 in that front panel 122 that allows directed, concentrated solar irradiance 130 (FIG. 1) to enter the cavity 120 and heat the heat transfer particles (not shown) falling therethrough from the inlet 114, along the receiver surface 151 and toward and through the outlet 118. The central opening/aperture 124 has a central aperture center line C (FIG. 1a). The concentrated solar irradiance 130 is from a solar source (not shown), such as a plurality of mirrors from a heliostat array. In the illustrated embodiment, the front panel 122 includes a single large central opening 12 that allow concentrated solar irradiance 130 to enter the cavity 120 and onto the particles falling down the various stages of the receiver surface 151.

The particle receiver 100 also includes a back-panel structure 126 which includes support framework 128 and 129 (FIGS. 2D and 2E) configured to hold and support the receiver surface panel 150 and to provide and maintain the required shape and configuration of the receiver surface 151 of the receiver surface panel 150.

The housing top structure 112 includes a particle feeding arrangement 170 comprising a particle hopper 171 configured to hold a volume of the heat transfer particles (not shown) for feeding onto the receiver surface 151. The particle feeding arrangement 170 comprises a slot type feeder. As best shown in FIG. 1(a) and 2D, the inlet 114 into the cavity 120 comprises a curved slot at the base of the hopper 171 positioned at the top side of the receiver surface 151. The inlet 114 comprises a curved slot 172 having a curve that is configured to match the curved geometry of the upper vertically orientated section 152 of the upper section of the receiver surface panel 151 (see below). This curved shape ensures that the initially introduced particles from the particle feeding arrangement 170 form a shape matching the curved shape of upper section of the receiver surface panel 151. That curved inlet slot 172 may be formed from a single continuously curved opening (as illustrated) or a series of multiple openings, for example flat or planar openings that follow the curved shape of upper section of the receiver surface panel 151. The flow of particles through the inlet 114 from the hopper 171 is controlled by a slide gate 174 (best shown in FIG. 2D). As with the inlet slot 172, the curve of the slide gate 174 may be formed from a single continuously curved panel (as illustrated) or multiple panels/series of panels, for example flat or planar panels that follow the curved shape of inlet slot 172. Actuation of this gate 174 regulates the flow of particles fed onto the top of the upper vertically orientated section 152 of the receiver surface 150. The illustrated slide gate 174 is equipped with actuators 176 (controlled motors or the like) to control to the particle flow fed onto the receiver surface 151. The particle flow is controlled to meet the required horizontal flow distribution. It should be appreciated that multiple slide gates can be used to handle bigger and wider inlet gates for large scale receivers. In this respect, the slide gate 174 can be a combination of multiple (curved or straight) gate. In case of multiple gates, the gate can be designed to move backward to open so that multiple slide gates do not collide each other.

The outlet 118 of base structure 116 also comprises a curved slot matching the curve at the base of the receiver surface 151 proximate the outlet 118. Movement of particles through outlet 118 is also controlled by a gate, that controls flow of particles out from the receiver surface 151. The outlet is designed to accommodate all particles falling from the receiver surface 151. No control is typically used to accommodate the particle flow rate. A valve can be installed for on/off purpose only. The particles are then transported to a heat storage tank to be stored before transferring heat in a heat transfer section, where the stored thermal energy is transferred, and then recycled back to the hopper 171 of the particle feeding arrangement 170.

As best shown in the cross-sectional view shown in FIG. 1(a), the housing 110 and cavity 120 therein is thermally insulated with insulation 132 in at least the top panel 134 of the top structure 112, side panels 136, 137 and optionally also in front panel 122 and base structure 116. Thermal insulation can also be added behind particle receiver surface 150 to thermally insulate all walls of the particle receiver. Any suitable thermal insulation can be used, for example ceramic and/or glass fibre insulation products, thermal ceramic products such as ceramic bricks, tiles, micropore material or the like.

The receiver surface 151 is housed within the thermally insulated housing 110 and cavity 120. The illustrated receiver surface panel 150 is a shaped panel that has two main sections:
1. A cylindrically shaped upper section 152; and
2. A main body section 153 comprising the curved inverted cone shaped receiver surface.

Firstly, the upper section 152 of the receiver surface panel 150 comprises a curved vertically orientated zone of the receiver surface 151. This upper section is designed to be vertical to match the initial particle falling direction from the top hopper 171 occurs in a vertical direction. Since solar energy is provided to the receiver 100 in an upwardly direction (relative to the orientation of the receiver in FIGS. 1 and 2—i.e. upwardly as in the general direction from the base structure 116 towards the top structure 112), the initial vertical falling zone helps with direct reception of solar energy by the falling particles.

The main body section 153 of the receiver surface 151 comprises a curved receiver surface that has an inverted frustoconical shaped curve. That curve follows the outer hypotenuse surface of an inverted cone. A schematic of an inverted cone 190 is shown in FIG. 1(c) having height h, base radius r and hypotenuse l. The curved receiver surface 151 takes the shape of a portion the hypotenuse surface of a truncated portion (i.e. frustoconical shape) of that cone 190. That arcuate section of the cone surface can comprise an angle ϕ (FIG. 1(c)) of between 30 to 200 degrees section of the circumferential surface of the inverted cone. In the illustrated example, this angle ϕ is 75 degrees. However, it should be appreciated that the size of the portion (or vertical truncation angle) of the frustoconical surface is determined by the shape of solar field and other design factors.

The frustoconical shape receiver surface advantageously provides 1) inclined wall geometry; 2) horizontal continuity of particle falling surface owing to the curved surface thus creating even or continuous particle distribution, and 3) maximum capture of solar energy by forming a concave shape. As particles fall down, the inverted conical shape also provides narrower width with evenly thickening particle curtain, which increases solar energy absorptance.

The main body 153 of the curved receiver surface 151 is inclined to enable particles to cascade downwardly over that surface. The receiver wall is backward-tilted a selected angle degrees from the vertical axis. This angle is related to forming a stable multi-staging with forward overflowing. The smaller the inclination, the better the optics. In terms of conical shape, the the angle of incline of the main body section 153 is equal to the half-apex angle Θ of the theoretical cone 200 (FIG. 1(c)) from which the receiver surface has been derived. Any suitable angle of incline can be used, for example from 5 to 40 degrees, preferably 10 to 30 degrees from the vertical axis. In the illustrated example, the angle of incline Θ is 17.5 degrees.

In the illustrated embodiment, the receiver surface 151 is divided into four particle falling stages 158A, 158B, 158C and 158D, with each stage separated by a particle retention formation 160 configured to receive, accumulate and progressively discharging particles into a subsequent stage. The particle retention formations 160 retards particles falling through the receiver 100.

In the illustrated embodiment, the particle retention formations 160 comprise catch-and-release troughs 160A, 160B and 160C that installed in spaced apart locations along the falling path P of the receiver surface (See FIG. 1(b)) to create a multi-stag falling configuration. Whilst four stages are shown in the illustrated embodiments, the number of stages is determined by particle curtain thickness which is related to factors such as receiver capacity and operating condition.

The troughs 160 collect and retain the falling particles for a predetermined amount of time, and then release and allow the particles to continue to fall. In such a manner, the particles fall is retarded. As the particles fall and horizontally (measured from the front or opening side of the receiver to the opposing back of the receiver) disperse, the particles are collected by the trough 160 and released in a curtain, veil or other shape that has a predetermined horizontal length. In such a manner, the falling particle dispersement can be corrected to a predetermined width.

The troughs 160 are disposed within the housing 110 and vertically arranged so that the most upper trough 160A receives particles from the inlet 106 after falling down and past the upper vertically orientated section 152 of the receiver surface 151 in the direction shown by particle falling path P (FIG. 1(b)), and outputs or releases those particles to a next in sequence or second trough 160B disposed underneath thereof. The next in sequence, trough 160B thereafter releases those collected particles to a third trough 160C, which releases those particles to the outlet slot 118 and into collection bin or other particle collection device or system (not illustrated) located proximate the base structure 116 of the receiver 100.

In such a manner, particles falling into the upper most or first trough 160A receive irradiance, and the particles falling between the troughs and from the third trough also receive irradiance. In the illustrated embodiment, a single opening 124 is used with multiple heliostats aiming at various points on the receiver surface to heat the particles falling between collection troughs 160.

It should be appreciated that the inclined receiver surface in conjunction with the troughs 160 are designed to allow overflowing of particles in the direction of solar energy reception that protect the troughs from direct solar irradiance. Optimum angle of the rear wall inclination is determined by a combination of particle flow rate and the distance between troughs. It should be understood that particles fill the space above and contained by the troughs 160 in a manner that when the space if full, the particles impact contained particles, and may mix, and then particles overflow as shown by the flow represented by the dashed line P.

The receiver surface 151 and troughs 160 can be fabricated by using tiles, casted ceramic or other thermally durable materials including metals.

One design of the the receiver surface panel 150 is shown in FIGS. 2D and 2E. In this design, each of the receiver panel arrangement 200 comprises four falling stages each of which is constructed from a separate configured curved panel 152, 170A, 170B and 170C that fit vertically together to form the desired frustoconical shaped curve of the entire receiver surface 151.

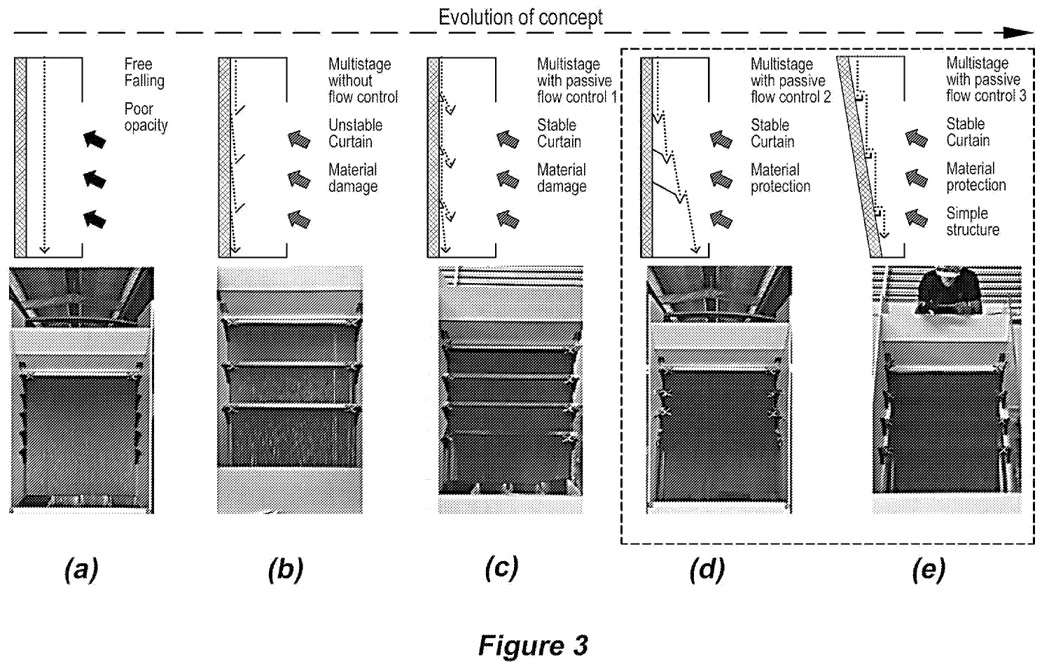

Here the upper (initial falling) section 152 is formed from a curved panel which follows a cylindrical curve which is designed to be vertical as the first fall of particles from the inlet 114 will be falling vertically. This section includes support element 153 (FIG. 4E) designed to support feeder plate 175 thereon.

The main body section 153 comprising three curved panels 170A, 170B and 170C configured with a frustoconical shaped curve. Each panel 170A, 170B and 170C is vertically stacked in framework 129 to form the overall frustoconical shaped curve of receiver surface 151. That framework 129 is formed of individual framework section 129A, 129B, 129C and 129D shown in FIG. 2E. Each of the four panel sections 152, 170A, 170B and 170C correspond with individual fall stages of the receiver surface and are separated or divided by catch and release troughs 160A, 160B and 160C, positioned therebetween.

As best shown in FIG. 2E, each catch-and-release trough 160A, 160B and 160C comprises an end section of a plate 161A, 161B and 161C which is positioned in between the respective panel sections 152, 170A, 170B and 170C. Each trough is formed by an L-shaped ledge that defines a trough cavity between the L-shape section of the plate 161A, 161B and 161C and the complementary adjacent section of the receiver surface 151. When in position between respective panel sections 152, 170A, 170B and 170C, each L-shaped ledge extends substantially perpendicularly outwardly to the receiver surface. Each L-shaped ledge is also configured with a complementary curve with the proximate portion of the receiver surface 151. The use of this type of plate 161A, 161B and 161C to form the troughs allow each trough 160A, 160B and 160C to be precisely positioned, serviced, and/or replaced from the rear of the particle receiver 100.

Whilst one embodiment of the receiver panel 150 is described and illustrated in relation to FIGS. 2D and 2E, it should be appreciated that each section of receiver surface can be made using a single curved plate, multiple curved plates, or multiple flat plates to form a part of cylindrical or conical shape.

Again, the housing top structure 112 includes a slot type feeder comprising a feeder plate 175 in which the curved slot inlet 114 is located and provides access into the cavity 120 (FIG. 1) via slide gate 174.

The base structure 116 comprises a plate 117 which includes curved slot outlet 118. Particles from the final panel 170C of receiver surface 151 are funnelled towards the outlet 118 by the receiver surface 151 on that panel 170C and also a flow deflector 180. The illustrated flow deflector 180 comprises a curved surface opposing the receiver surface about the particle outlet of the receiver. The flow deflector 180 has a frustoconical shaped configuration which is preferably complementary to the frustoconical shaped configuration of the base section of the receiver surface 151. This provides an inclined curved surface in an opposing incline to the receiver surface 151. The flow deflector 180 is positioned and configured to decelerates particle velocity separating entrained hot air from the particles and air flow before leaving the receiver cavity 120 so that the entrained hot air is recirculated and used as the entrained air within the receiver.

The design of the present invention therefore provides the following improvements or differences over previous multi-stage falling particle receivers:
The cone-shape receiver surface design provides a geometry with backwardly-inclined and horizontally-continuous surface at the same time, which is required for multi-stage falling particle receiver (with a protection of catch-and-release troughs by overflowing particles) and maximum capture of solar energy by forming a concave shape without using multiple receiver panels.
The insulated cavity embedding the cone-shape receiver surface minimises heat and particle loss and provides inlet and outlet gates of particle flow.
Curved slide gate equipped with single or multiple actuators provides a control to the inlet particle flow meeting the need of horizontal flow distribution.

### Example

In this study, the design of a 750 Wt cavity multi-stage falling particle solar receiver was implemented. The new falling particle receiver was designed with truncated-cone geometry as shown and described above in relation to FIGS. 1 and 2. Combining truncated-cone geometry and four falling stages, overall solar energy absorptance of particle curtain was estimated to be higher than 92% in the design condition. Design capacity of the receiver is around 750 kWt at solar noon on the equinox with a potential to accommodate more energy without serious material constraint. Ray tracing result and high-level heat loss breakdown (reflection and emission only) are provided along with receiver geometry. A schematic of receiver on-sun test system and configuration of integrated components are also provided.

### 1. OPTIMISING A MULTI-STAGE FALLING CONFIGURATION

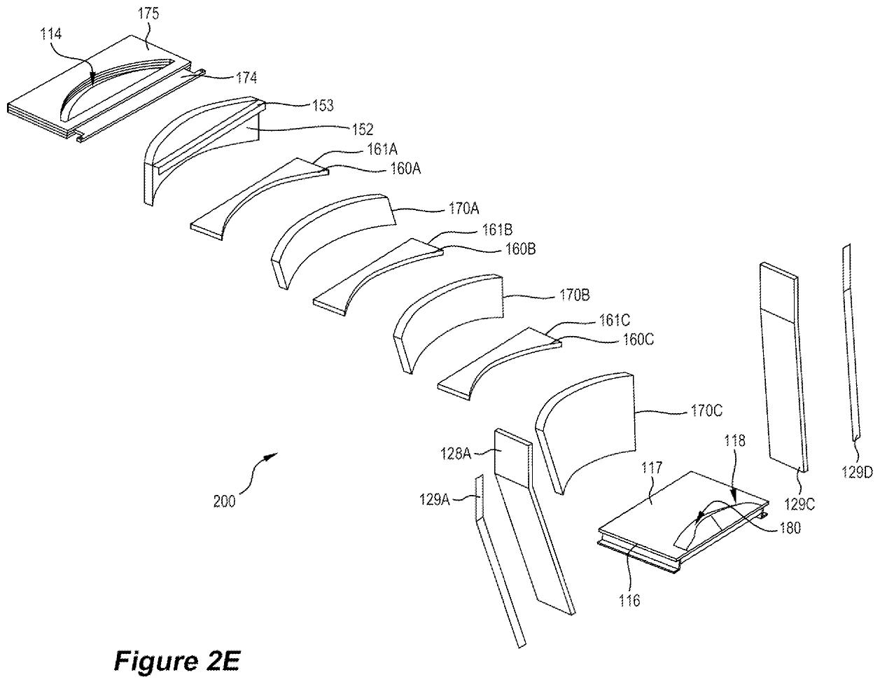

In order to identify suitable multi-stage falling configurations, a small (1 m wide and 1 m high) falling test rig was built and operated to experimentally validate various ideas. FIG. 3 shows the evolution of the multi-stage falling concept developed by the inventors with snapshots taken from different falling tests. A reduction in absorptance in a simple free-falling particle curtain (FIG. 3(a)) can be resolved by using the multi-stage falling concept which creates a number of flow connected particle fall curtains with high-opacity (FIG. 3(b)). However, each catch-and-release trough requires some control to maintain a proper in-trough particle level which assists in creating a stable re-falling. Active control of trough discharge aperture incurs additional cost and design complexity. Therefore, a new design comprising 1) asymmetric V-shape troughs creating wall-side overflow and 2) deflectors to redirect the particle flow toward next troughs, was developed (FIG. 3(c)) thereby creating high-opacity particle falling stages without needing an active control of particle flow in the individual trough.

However, the drawback of the design in FIG. 3(c) is that the catch-and-release troughs are directly exposed to concentrated solar energy. The solar energy delivered to the surface of the trough material will not be efficiently used for heating particles and also places high thermal demands on the trough material. Therefore, a 4^{th} concept (FIG. 3(d)) was developed by designing the particle overflow in the trough occurring toward the direction of solar energy provision so that the trough material can be protected from solar energy. With this concept, the entire receiver surface can be covered by particle flow. In the concept, due to the non-vertical trajectory of particle falling, each trough needs to be positioned with some indentation to catch the particles falling from the previous stage. The structural complexity of this concept can be avoided by using an inclined wall (5^{th} concept—FIG. 3(e)) and wall-attached troughs. This 5^{th} concept was further developed into a test solid particle solar receiver.

### 2. RECEIVER DESIGN

### 2.1 Frustoconical Receiver Geometry

As best shown in FIGS. 2(a) to 2(c) (described in detail previously), the designed particle receiver 100 comprises a housing having a thermally insulated cavity to minimize heat and particle losses. The receiver surface 151 (over which the falling particle curtain is formed in the particle receiver) is configured to be concave to capture the most solar energy delivered from wide range of angular direction. For this, conventional tubular receivers use multiple receiver panels to form an optimal concave shape of receiver surface. But the chosen multi-stage falling concept with an inclined wall has a geometrical difficulty to be implemented to the receiver design having a concave surface.

This design issue has been innovatively resolved by the Inventors by designing the receiver surface 151 to follow the shape of an incline frustoconical (truncated cone) geometry (i.e. a section of the surface of an inclined frustoconical shape). FIG. 1(b) shows the concept of receiver surface with truncated-cone geometry along with the indication of particle flow path. As previously described, the upper section of the receiver is designed to be vertical as the initial particle falling from the top hopper occurs in vertical direction. Since the solar energy is provided to the receiver in upward direction, the initial vertical falling zone helps with direction reception of solar energy by falling particles. Following the vertical section, the frustoconical shape receiver surface is provided. This section of the receiver surface provides: 1) inclined wall geometry which is essential for the chosen multi-stage falling concept, 2) horizontal continuity of particle falling surface owing to the curved surface thus creating evener and continuous particle distribution, 3) maximum capture of solar energy by forming a concave surface, and 4) converging falling path connected to outlet gate.

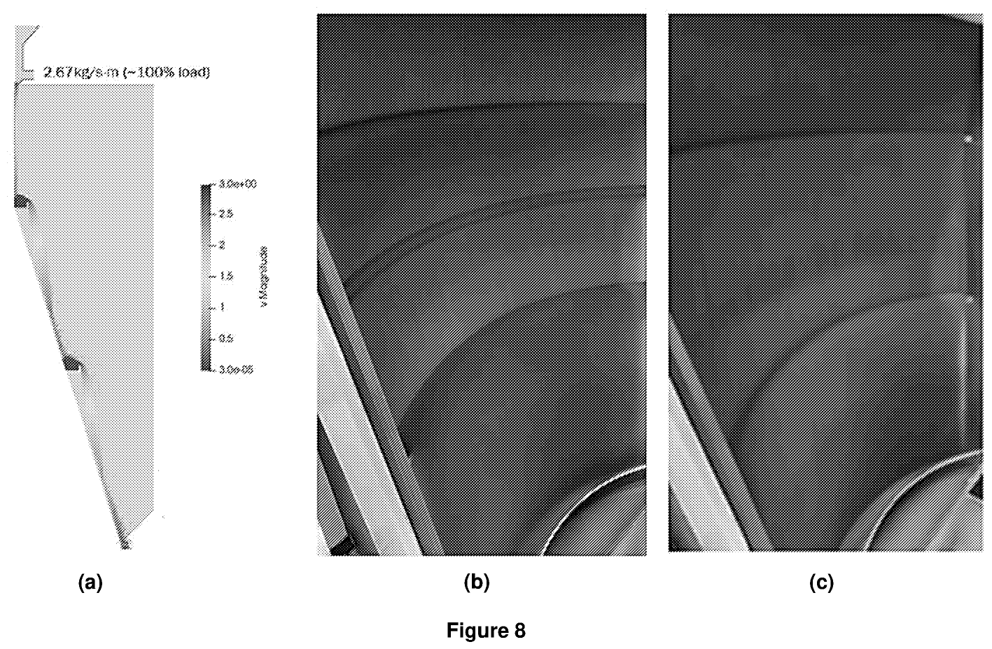

The cut angle (75 degree in this study) of the frustoconical surface is determined by the shape of solar field and design decision. Four catch-and-release troughs were used to create a four-stage particle falling configuration. However, as noted below, the final test design ended up with using three stages by not using the second trough (as shown and described below in relation to FIG. 8). The number of stages is selected to achieve a desired absorptance is determined by particle size and particle curtain thickness (represented by flow rate per width of particle curtain) which is related to receiver capacity and operating condition.

The illustrated particle receiver panel 150 and surface 151 and the troughs 160 therein can be constructed from bent, machined, or moulded materials including metal, a metal alloy, ceramic or other high temperature materials. The illustrated receiver panel was constructed from stainless steel (austenitic stainless steel 253MA).

### 2.2 Design of On-Sun Test Receiver

### 2.2.1 Particles

40/70 mesh commercial ceramic proppant Wanli HSP (from Xinmi Wanli Industry Development Co. Ltd, Henan, China) was selected for use in the initial test solid particle solar receiver. The basic particle properties used for receiver design are listed in Table 1:

TABLE 1
Properties of the Wanli HSP receiver ceramic particle.

| | | |
|---|---|---|
| Average particle size | 377 | μm |
| Density | 3105 | kg/m3 |
| Heat capacity | 1.2 | kJ/kg-K |

| | |
|---|---|
| Packed-bed absorptance (solar-weighted) | 0.91 |

### 2.2.2 Receiver Design Condition and Geometry

Design condition and geometry of an on-sun test receiver are provided in Table 2.

TABLE 2
Design condition and receiver geometry.

| Design condition | |
|---|---|
| Test system location | Newcastle, Australia |
| Optical tower height, m | 26.8 |
| Intended design capacity (at SN-equinox), kWt | ~750 kWt |
| Particle flow rate (corresponding to slightly | 3.08 |
| smaller capacity than the designed referring | |
| to ray tracing result), kg/s | |
| Particle flow rate per curtain width, kg/s-m | 2.47 |
| Receiver inlet/outlet temperature | 600° C./800° C. |
| Receiver geometry | |
| Diameter of cavity aperture, m | 0.8 |
| Tilting angle of aperture, degree | 45 |
| Width of initial particle curtain (width | 1.25 |
| of slide gate), m | |
| Width of the final particle curtain, m | 0.85 |
| Total height of particle curtain, m | 1.25 |
| Total area of particle curtain, m² | 1.43 |
| Number of falling stages | 4 |

The receiver tests were carried out in the CSIRO solar field in Newcastle, Australia which comprises heliostat field with 2000 m² reflector area and 25 m high tower.

Intended design capacity at solar noon (SN) on the equinox is around 750 kWₜ. However, particle receivers, unlike tubular receivers, are expected to be operable with excess solar energy without a serious material constraint. Inlet and outlet particle temperature were assumed considering operating condition of a supercritical CO₂ power cycle and associated heat exchanger effectiveness.

The receiver geometry was determined considering optical characteristics of solar field, tower height and estimated receiver performance.

### 2.2.3 Absorptance

In order to determine required number of falling stages, the absorptance correlation equation (1) (below) was used with updated parameters corresponding to the size and density of Wanli HSP particles used in this study. Calculated absorptance changes along the falling height are shown in FIG. 4 for different flow rates. In FIG. 4, the solar energy absorptance of falling particles of 40/70 mesh Wanli HSP was obtained by correlation equation (1):

$$Absorptance = {A}_{1} + ( {A}_{2} - {A}_{1} ) [ \frac{p}{1 + {10}^{( {L}_{1} - log ( x ) + S ) {h}_{1}}} + \frac{1 - p}{1 + {10}^{( {L}_{2} - log ( x ) + S ) {h}_{2}}} ] , S = 0.889 ln ( m ) - k \qquad ( 1 )$$

where x is falling height (m), m is flow rate per curtain width (kg/s-m), A₁=0.30482, A₂=0.93366, L₁=−0.1201, L₂=0.5575, h₁=−1.85995, h₂=−1.49412, p=0.28897, k=1.035 (assumptions: collimated solar radiation, gravity-driven vertical falling with no drag, particle shape is sphere, particle size is 377 um).

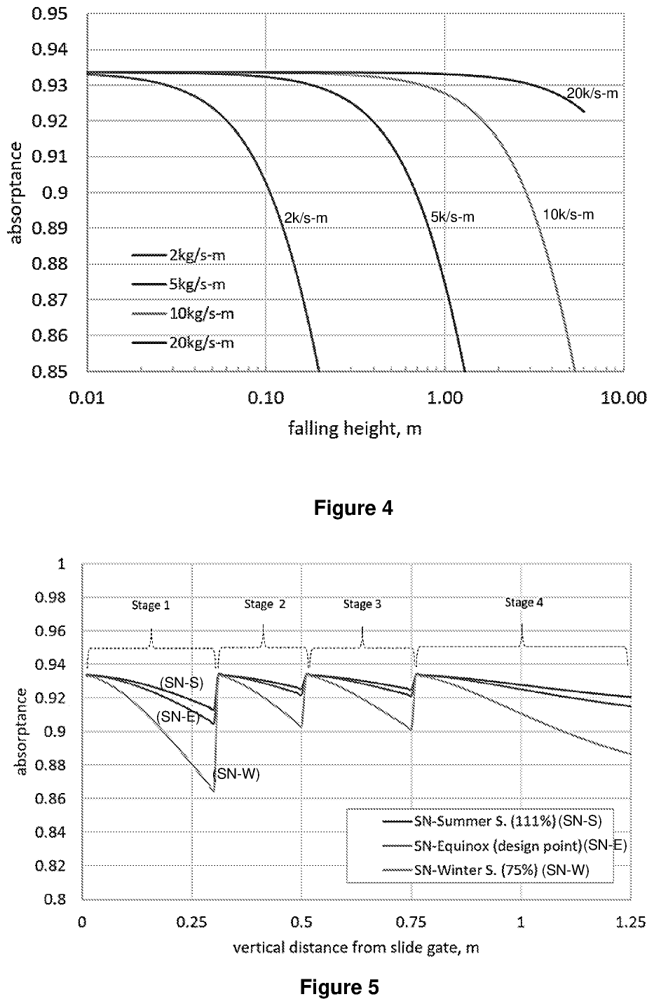

In this study, as illustrated in FIGS. 1 and 2, a total of four falling stages were finally implemented to the receiver design. However, it should be appreciated that any number (two or more) of fall stages can be used depending on the size and design of the particle receiver. Estimated solar energy absorptance change for each stage of the designed receiver is plotted in FIG. 5 for three different operating times (different capacities). The absorptance value was estimated using the correlation provided in FIG. 4 and also considering the incident angle of the solar energy to the particle curtain and decreased width of particle curtain by the frustoconical geometry. For simplicity, the trough was assumed as a point providing complete stop and new falling of particles between stages. Average absorptance of each stage and overall absorptance are listed in Table 3. In comparison with the absorptance of free falling, the multi-stage falling design gives 7˜16% higher absorptance for the same height of vertical falling.

TABLE 3
Average solar energy absorptance of each falling stage.

| | | | average absorptance | | |
|---|---|---|---|---|---|
| | | height, | SN-Summer | | SN-Winter |
| | | m | solstice | SN-Equinox | solstice |
| multistage | stage 1 | 0.3 | 0.926 | 0.922 | 0.905 |
| falling | stage 2 | 0.2 | 0.930 | 0.929 | 0.921 |
| | stage 3 | 0.25 | 0.930 | 0.928 | 0.920 |
| | stage 4 | 0.5 | 0.927 | 0.925 | 0.910 |
| | overall | 1.25 | 0.928 | 0.925 | 0.913 |

| | | | | |
|---|---|---|---|---|
| free falling | 1.25 | 0.867 | 0.849 | 0.784 |

### 2.2.4 Ray Tracing

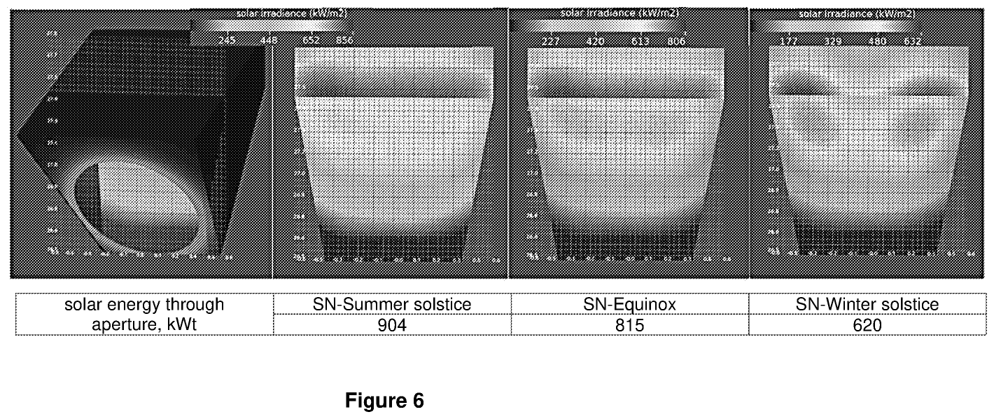

Incident solar energy provided to particle curtain was obtained by HelioSIM ray tracing simulation (as taught in D. F. Potter, J.-S. Kim, A. Khassapov, R. Pascual, L. Hetherton and Z. Zhang, Heliosim, An integrated model for the optimisation and simulation of central receiver CSP facilities, AIP Conference Proceedings 2033, 210011 (2018), the contents of which should be understood to be incorporated into this specification by this reference). FIG. 6 shows contour plots of solar flux profile on the cavity receiver and on the falling particle curtains at different seasons. The flux shown in FIG. 6 is including the solar energy delivered after reflections from the walls and ceiling (considering 70% diffusional reflection).

The HelioSIM ray tracing obtained 815 kWₜ as the total energy provided through the receiver aperture plane at solar noon (SN) on the equinox (design condition). Combining the ray tracing result and the absorptance of multistage falling, estimated energy losses by different causes were 2.7% by reflection from particles, 3% by reflection from inner walls and ceiling, 3.3% by emission from particle and 0.5% by emission from inner walls and ceiling, respectively. Estimated advection heat loss ranges 1.2 to 2.6% depending on the wind condition. The 3% energy loss caused by reflection from inner walls and ceiling is due to the bigger relative tower height compared to commercial systems and also due to the narrow widths of the particle curtain designed for experimental purpose. The loss is not likely and will be negligible in commercial-scale particle receivers.

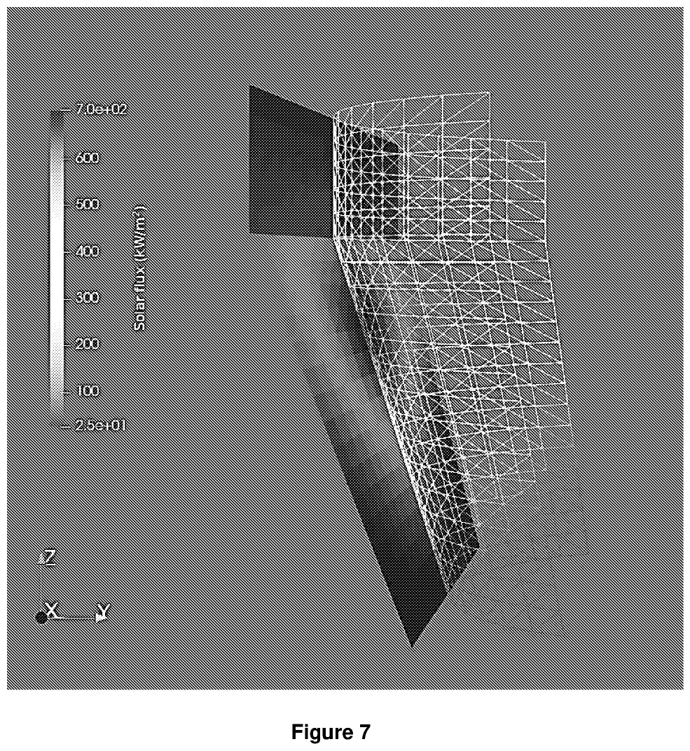

In addition, FIG. 7 provides solar flux contour plots on the receiver surfaces with a flat-tilted and a cone-shaped receiver wall. Here, ray tracing for a 50 MWt-scale particle receiver with a cavity revealed that the amount of solar energy captured by the cone-shaped receiver is about 11% higher than the energy by a tilted flat-wall receiver with the same area.

### 2.2.5 Indoor Falling Test

An indoor test receiver was constructed as shown in FIGS. 2D and 2E. The receiver consisted of a distribution hopper, a 1.22 m curved slide gate operated by two linear actuators, receiver walls split by catch-and-release troughs for multi-stag falling.

An indoor test system using this indoor test receiver was used for the final validation of the receiver concept in a full scale. The indoor test system includes a top hopper to supply particle into the test receiver, a bottom bin equipped with a load cell for flow rate measurement and a screw conveyer to lift the particle back to the top bin. Indoor particle falling using the indoor test system was carried out in various flow rate conditions. The test receiver was designed with the ability to adjust the indentation of each trough from the wall so that the optimum size of the trough can be experimentally identified.

FIG. 8 provides the results of a multi-stage particle falling simulation, showing: (a) shown with vertical velocity contour; (b) multi-stage falling tests in a part-load flow and (c) tested with full load for truncated-cone shape design. The monitored particle falling hydrodynamics were found to have suitably even particle coverage and particle curtain development. Through the test, the multi-stage falling concept was successfully validated to be working as intended.

### 2.3 Receiver Test System

### 2.3.1 Test System Design

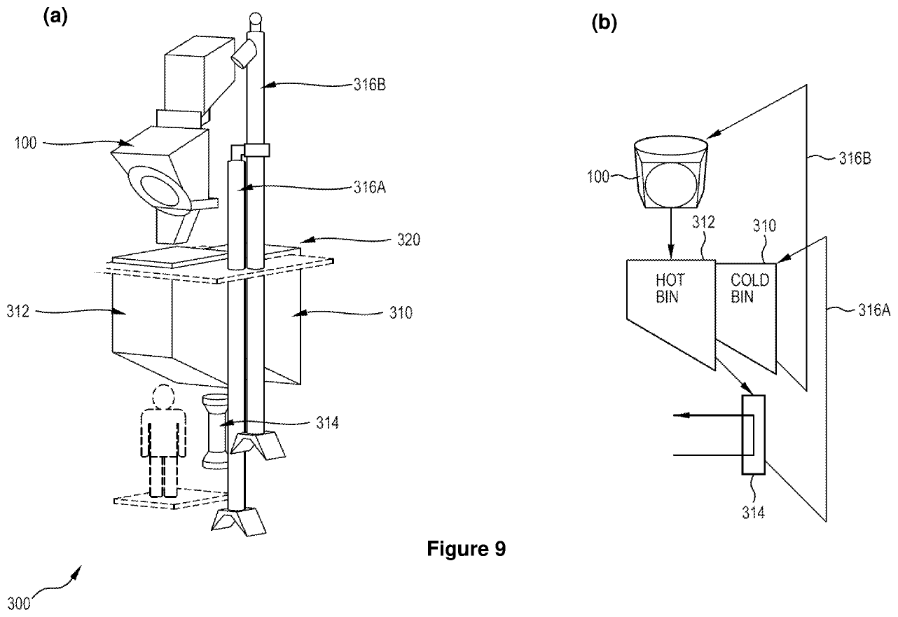

FIGS. 9(a) and 9(b) show a configuration of 750 kWt particle receiver on-sun test system 300. The test system will consist of a receiver 100 as described above and illustrated in FIGS. 1 and 2, a hot particle storage bin 310 and cold particle storage bin 312, a cooler 314 to reject heat and two screw conveyers 316A and 316B to lift particles form the cooler 314 to the cold bin 312 and from the cold bin 312 to the particle receiver 100. The volume of each storage bin 310, 312 will be around 2 m³ which is comparable to 20 minutes of design load thermal storage. The particle receiver 100 is typically mounted on a tower platform 320, at a height at which a concentrated solar beam from multiple heliostats are able to be directed into the opening/aperture of the particle receiver 100 to heat the particles flowing through the particle receiver 100. Based on this design, once the particles are lifted to the top hopper above the receiver, the particles flow/settle down (through a distribution hopper, receiver, storage bin) by gravity before being lifted up again by the screw conveyer.

### 2.3.2 Heat Transfer Particles

Two commercially available high density 40/70 ceramic proppants products, Wanli HSP 40/70 mesh (from Xinmi Wanli Industry Development Co. Ltd, Henan, China) and Carbobead HSP 40/70 mesh (from Carbo Ceramics Inc, Houston, Texas, USA) were considered for on-sun testing of the test particle receiver. Carbobead HSP was chosen to be used for on-sun test due to Carbobead HSP's superior property compared to the Wanli HSP. In this regard, the Carbobead HPS has a 20% higher density, 2% higher absorptivity and more consistent product quality compared to Wanli HSP.

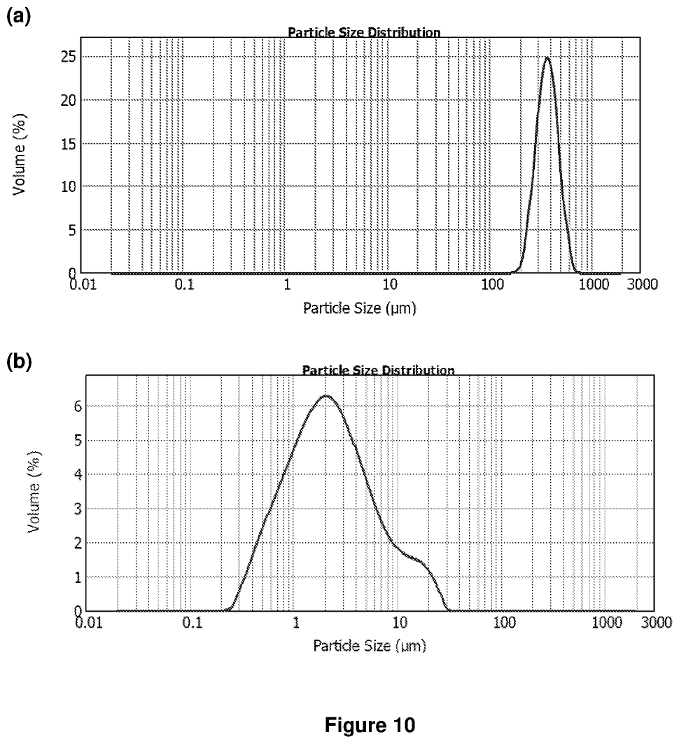

The size distribution of the Carbo HSP 40/70 mesh particles and the fines included in the particle product were measured by a laser diffraction method. The results are provided in FIG. 10. The volume weighted mean diameter D were 381 um for the particle products and 3.784 um for the fines separated from the particles.

### 2.3.3 Early-Stage Operation

Commissioning stages and early-stage operation of the system using Carbo HSP 40/70 mesh particles focused on the demonstration of on-sun test engaging both solar field and receiver test system. Operation of the receiver design was successfully tested with solar energy input by the solar field to the falling particle receiver confirming continuous on-sun operation of particle circulation (in 100% flow, 2.9 kg/s) and small amount of solar input. Early-stage operation experiments confirmed that the proposed design could create stable and well distributed falling particle curtain similar to that shown in FIG. 8 and could capture solar energy provided by the solar field.

### 3. CONCLUSIONS

In order to implement the chosen multi-stage falling concept to the design of a real receiver, a receiver surface with a truncated-cone geometry has been developed.

The tested design of the multi-stage falling particle receiver obtained through optical and thermal analysis consists of 1) a cavity with an aperture of 0.8 m diameter and 45 degree tilting angle, four-stage falling particle receiver surface with a truncated-cone geometry, a curved slide gate for particle inlet at the top of the receiver and another gate for particle outlet at the bottom. The design capacity of the receiver is around 750 kWt at solar noon on the equinox. The tested design has an 88% efficiency.

The designed receiver was fabricated along with other components required for on-sun receiver test. On-sun testing validated the function of the designed particle receiver.

Those skilled in the art will appreciate that the invention described herein is susceptible to variations and modifications other than those specifically described. It is understood that the invention includes all such variations and modifications which fall within the spirit and scope of the present invention.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof.

1. A solid particle solar receiver comprising:
a housing which includes at least one opening for receiving concentrated solar irradiance; and an inclined receiver surface about and along which particles fall downwardly from a particle inlet, the receiver surface being located in the housing in a position through which concentrated solar irradiance can incident through the at least one opening,
wherein the receiver surface comprises at least two particle falling stages, each stage separated by at least one particle retention formation configured to receive, accumulate and progressively discharging particles into a subsequent stage,
and wherein the receiver surface is configured with a frustoconical shaped curve.

2. The solid particle solar receiver according to claim 1, wherein the receiver surface has an inverted frustoconical shape, preferably a vertically truncated frustoconical shape.

3. The solid particle solar receiver according to claim 1, wherein the receiver surface includes an upper section configured with a substantially cylindrically shaped curve.

4. The solid particle solar receiver according to claim 1, wherein the receiver surface is formed from:
at least one curved body, preferably at least one curved panel, more preferably at least two curved panels; or
a plurality of planar bodies, preferably panels, in a tessellated arrangement to form the requisite curved surface or surfaces.

5. The solid particle solar receiver according to claim 4, wherein the receiver surface is formed from at least two curved bodies defining each particle falling stage, each curved body separated by a particle retention formation position therebetween.

6. The solid particle solar receiver according to claim 5, wherein each particle retention formation comprises a removable element configured to be located between each curved body and wherein each particle retention formation is optionally formed as part of a sheet or plate configured to be removable located between each curved body.

7. (canceled)

8. The solid particle solar receiver according to claim 1, wherein the receiver has a vertical axis and the receiver surface is inclined at an angle of 5 to 50 degrees, preferably 10 to 30 degrees from the vertical axis.

9. The solid particle solar receiver according to claim 1, wherein the receiver surface comprises a 30 to 200 degrees section of the circumferential surface of the inverted cone, preferably 60 to 120 degrees.

10. The solid particle solar receiver according to claim 1, wherein the particle retention formation comprises at least one flange, trough, groove or ledge formed in or attached to the receiver surface.

11. The solid particle solar receiver according to claim 1, wherein the particle retention formation is configured to receive, accumulate and progressively discharging particles into the subsequent stage of the receiver surface, creating a cascade of falling particles away from the receiver surface as the particles fall through the receiver.

12. The solid particle solar receiver according to claim 1, wherein the one or more flow retention devices comprise troughs, and wherein the troughs optionally comprise an L-shaped ledge which substantially perpendicularly to the receiver surface which is configured with a complementary curve with the proximate portion of the receiver surface.

13. (canceled)

14. The solid particle solar receiver according to claim 1, wherein the particle retention formations are positioned within the housing so that the particle retention formations are not irradiated by concentrated solar irradiance entering the receiver.

15. The solid particle solar receiver according to claim 1, wherein each particle retention formation includes at least one of the following:
is designed to form a cascade of falling particles protect the particle retention formation from concentrated solar irradiance entering the solar receiver;
is spaced apart from an adjacent particle retention formation along the inclined length of the receiver surface; or
is configured to direct particle flow downward along the receiver surface and towards a base of the particle receiver.

16. (canceled)

17. (canceled)

18. The solid particle solar receiver according to claim 1, wherein the receiver surface includes at least one particle falling stages for every 2 meters of vertical height in the receiver surface.

19. The solid particle solar receiver according to claim 1, wherein the housing includes a particle feeder for feeding particles onto the receiver surface at or proximate the top of the receiver surface and a particle outlet at or proximate the bottom of the receiver surface, and wherein the particle feeder optionally has at least one of:
a curved opening slot having a matching curve to the to make the top portion of the receiver surface proximate the particle inlet; or
multiple straight/planar opening slots arranged to have a substantially matching curve to the to make the top portion of the receiver surface proximate the particle inlet.

20. (canceled)

21. The solid particle solar receiver according to claim 19, wherein the particle feeder has a curved slide gate or multiple slide gates forming a complementary curved shape to the curved opening slot, and wherein wherein the curved slide gate is optionally equipped with at least one actuator to control to the particle flow fed onto receiver surface.

22. (canceled)

23. The solid particle solar receiver according to claim 1, further including at least one flow deflector located proximate the bottom of the receiver surface, the flow deflector configured to deflect particle motion from particles falling the final particle falling stage prior to exiting through the particle outlet, and wherein the at least one flow deflector is optionally configured to decelerate particle velocity and separate entrained air from the particles.

24. (canceled)

25. The solid particle solar receiver according to claim 1, wherein the housing includes a cavity in which the receiver surface is housed, the opening being formed through the housing into the cavity, and wherein the cavity is optionally thermally insulated to minimise heat loss through the housing.

26. (canceled)

27. The solid particle solar receiver according to claim 1, wherein the receiver surface and particle retention formation therein comprise at least one thermally durable material, preferably metal, tiles or casted ceramic.

28. The solid particle solar receiver according to claim 1, wherein the particles comprise ceramic particles, preferably solid granular ceramic particles, more preferably 40/70 mesh commercial ceramic proppant.
